(19) United States
(12) Patent Application Publication
(10) Pub. No.: US 2006/0288341 A1
(43) Pub. Date: Dec. 21, 2006

(54) Patch-impact assessment through runtime insertion of code path instrumentation

(75) Inventors: Frederick L. Wurden, Redmond, WA (US); David Neil MacDonald, Mercer Island, WA (US); Eric Sami Bahna, Seattle, WA (US); N. K. Srinivas, Sammamish, WA (US); Patrick Chiu, Redmond, WA (US); Paul Vendley Donlan, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/154,089

(22) Filed: Jun. 15, 2005

(51) Int. Cl. G06F 9/44

(52) U.S. Cl. 717/168

(57) ABSTRACT

Runtime patch validation is provided that instruments an in-use function to determine whether the function needs a patch and/or how the patch will impact the function. Patch validation code is instrumented into a target binary when the target binary is running. Patch validation data is gathered from the instrumented target binary and provided for viewing and analysis.

### BACKGROUND

Nowadays, most software programs undergo a continual revision process to repair or update features in the software programs. A software program may be an operating system, an application program, or any software component. Revision of a software program frequently includes updating or patching existing files with newer revisions. Generally speaking, “patching” refers to the art of modifying or updating a software program from one state to another state. Often, patching is performed if a software program is in need of a service release or update to remedy a programming bug or other infirmity. Patching is traditionally performed by executing a patching application, which makes minor modifications to the installed program's files or resources.

Once a software provider has created a patch for a software program either to fix a problem, to enhance security, or to add new features, the software provider will want to make that patch widely available to the appropriate customer base. Quite often, such as when the patch is directed at correcting a flaw in the program or addressing a critical security issue, the software provider will want that patch installed on the customers' computers as soon as possible.

However, patching a software program traditionally requires stopping the software program and/or rebooting the computer system running the software program. Such interruptions in deploying a patch may lead to loss of service or significant production down time for a customer. Furthermore, testing work may be required to validate that a new patch does not threaten system stability or data integrity. Such patch validation can be expensive and inexact. For example, a network administrator may wish to patch programs throughout the network that have been threatened by a virus. However, the patched programs will not begin running on a system until each patched system is rebooted, thus causing a substantial amount of system downtime in the network and leading to customer inconvenience and loss of revenue. Meanwhile, prior to deploying a patch, the network administrator may be required to test the to-be-patched system to ensure system stability and data integrity in association with the changes caused by the patch. Hence, deploying a patch for a software program can be very expensive.

Thus, before deploying a patch for a software program, it is desirable to determine whether the deployment is necessary for a particular customer. A customer of the software program may have configured to use the software program in a way that makes the deployment of the patch unnecessary or of high risk. For example, the customer may have configured the software or hardware environment in which the software program executes in such a way that the code affected by the patch is actually not used. Yet, it is often difficult to determine whether and how a software program is affected by the patch in view of a customer's particular configuration of the software program.

Therefore, it is desirable to instrument binaries affected by the proposed patch in use by a software program while the software program is running and to analyze the instrumented binaries for traversal by the software program during its intended use. In such a way, the software program is not stopped and the system running the software program is not rebooted, thus allowing for minimal interruption to the operation of the system or the software program. Meanwhile, the run-time instrumentation and diagnosis of the software program helps determine whether the deployment of the patch is necessary. Identifying whether a patch is needed for a specific software program before installing the patch eliminates required targeted validation testing, hence reduces service costs and increases customer satisfaction.

### SUMMARY

The invention addresses the above-identified needs by enabling runtime instrumentation of a running process, without the process being aware of the insertion, and with minimal impact on the process or the system that the process is running on. The invention can be used to determine whether a code patch will be used on the system, and how often.

One aspect of the invention identifies patch validation needs, i.e., needs for validating whether a patch will be used on a target binary and how the patch will impact the target binary. According to the identified patch validation needs, a patch validation package is built. The patch validation package includes a patching mechanism that instruments the target binary with patch validation code when the target binary is in execution mode. The patch validation package also includes a patch validation server process component that gathers patch validation data resulting from executing the instrumented target binary. The patch validation server process component may write the gathered patch validation data to a specified location. Such a location may be local to the platform running the target binary, such as a local console for viewing the patch validation data in near real time, or to a remote platform. The patch validation package may further include a patch validation logging interface. Through the patch validation logging interface, a user-mode target binary instrumented with patch validation code communicates with the patch validation server process component.

In accordance with another aspect of the invention, after a patch validation package is built, the patch validation package is installed on the platform where the target binary is running. Preferably, the installation of the patch validation package inserts a jump before the code in the target binary that is to be affected by the patch at issue. The execution of the jump leads to the execution of the installed patch validation code.

In accordance with a further aspect of the invention, the gathered patch validation data may be viewed through a command-line console or through a graphic user interface.

Yet another aspect of the invention removes the patch validation package from the platform after the patch validation data have been collected, restoring the system to its original state without service interruption. Alternatively, a new patch validation package may be installed over an old patch validation package without service interruption. The new package, too, can be removed to restore the system to its original state.

In summary, the invention instruments a software program when it is running to analyze whether the software program needs a patch and how the patch will impact the execution of the software program. Consequently, patch validation for a software program is performed without stopping the software program or rebooting the system running the software program. Such an approach of runtime instrumentation of a software program to decide whether the software program needs a patch before installing the patch reduces service costs and increases customer satisfaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary computer system for implementing aspects of the invention;

FIG. 2 is a block diagram illustrating an exemplary runtime patch validation program;

FIG. 3 is a block diagram illustrating aspects of the invention wherein the target binary is in user mode;

FIG. 4 is a block diagram illustrating aspects of the invention wherein the target binary is in kernel mode;

FIG. 5 is a flow diagram illustrating an exemplary process for runtime patch validation; and

FIG. 6 is a flow diagram illustrating an exemplary routine for logging and viewing patch validation data, suitable for use in FIG. 5.

### DETAILED DESCRIPTION

Embodiments of the invention instrument a runtime process to diagnose whether the runtime process (“target binary”) needs a patch and how the patch will impact the execution of the target binary. A patch validation package is built based on specific patch validation needs. The patch validation package includes a patching mechanism that instruments a target binary when the target binary is in execution mode. The patch validation package also includes a patch validation server process component that gathers patch validation data resulting from executing the instrumented target binary. The gathered patch validation data can be viewed locally or remotely, offline or in near real time. Installed patch validation package can be removed or replaced with new versions of patch validation package.

In the following paragraphs, various aspects and embodiments of the invention will be described. Specific details will be set forth in order to provide an understanding of the described embodiments of the present invention. However, it will be apparent to those skilled in the art that the described embodiments may be practiced with only some or all of the described aspects, and with or without some of the specific details. In some instances, descriptions of well-known features may be omitted or simplified so as not to obscure the various aspects and embodiments of the present invention.

Parts of the description will be presented using terminology commonly employed by those skilled in the art to convey the substance of their work to others skilled in the art, including terms of operations performed by or components included in the information management system. For example, the term “system” includes general purpose as well as special purpose arrangements of these components that are stand-alone, adjunct or embedded.

In addition, various operations will be described as multiple discrete steps performed in turn in a manner that is most helpful in understanding the present invention. However, the order of description should not be construed as to imply that these operations are necessarily performed in the order they are presented, or even order dependent.

References to “one embodiment” or “an embodiment” throughout this specification mean that a particular feature, structure, or characteristic described in connection with the embodiment is included in at least one embodiment of the present invention. Thus, appearances of the phrase “in one embodiment” or “in an embodiment” in various places throughout the specification are not necessarily all referring to the same embodiment.

The following text will first describe in detail an exemplary computer system for implementing aspects of the invention. Then an exemplary runtime patch validation program is described that includes exemplary components for instrumenting a running target binary to diagnose the need and the impact of a patch for the target binary. Finally, a computer-implemented method is described illustrating an exemplary process for runtime patch validation of a target binary.

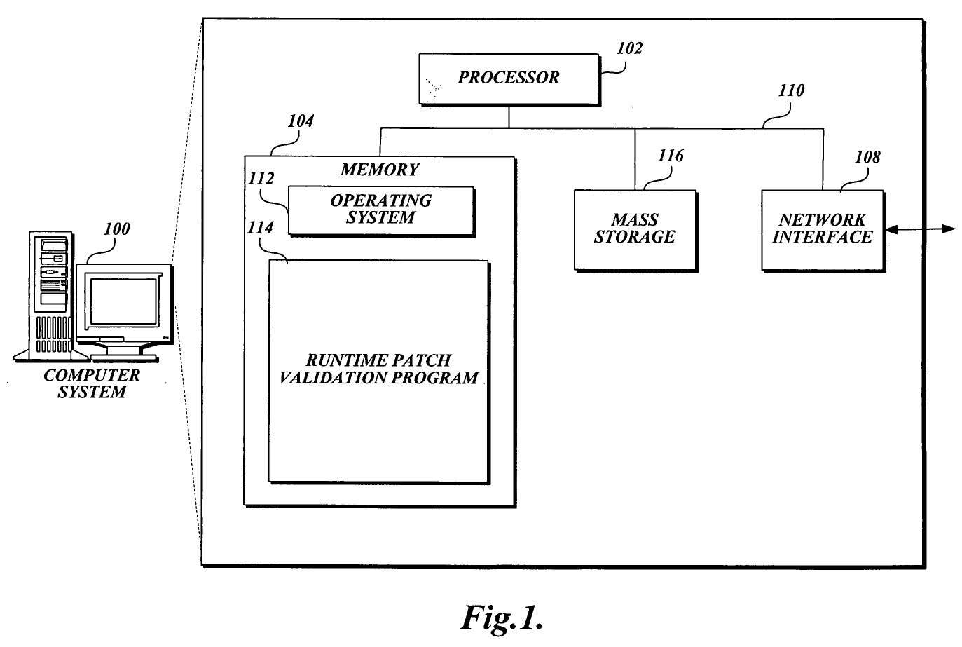

FIG. 1 depicts an exemplary computer system 100 suitable for use in implementing aspects of the invention. The computer system 100 includes a processor 102 and a memory 104. The processor 102 is configured to operate in accordance with computer program instructions stored in a memory, such as the memory 104. Program instructions may also be embodied in a hardware format, such as a programmed digital signal processor.

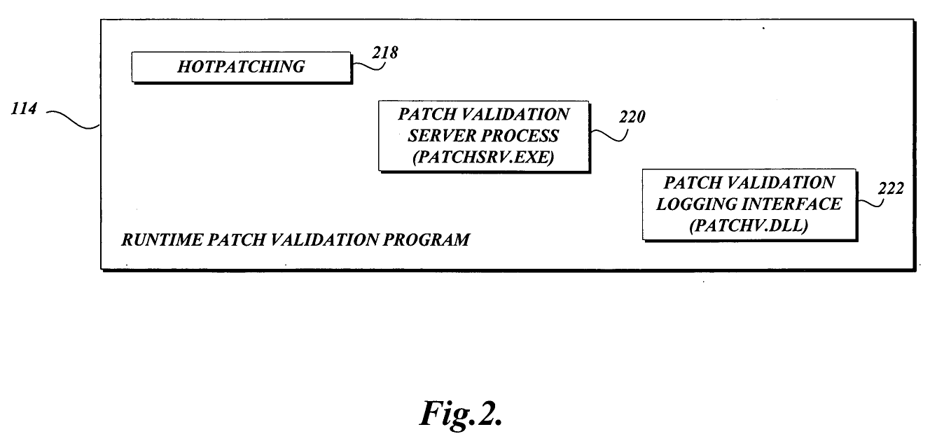

The memory 104 may be comprised of any type of storage facility, and may include, by way of example, RAM, ROM, and/or removable computer-readable media. The memory 104 may store an operating system 112 for controlling the operation of the computer system 100. The operating system 112 may be a general-purpose operating system such as a Microsoft operating system, for example. The memory 104 additionally stores program code and data that provide a runtime patch validation program 114. The runtime patch validation program 114 comprises computer-executable instructions that, when executed by the processor 102, cause the computer system 100 to instrument a running target binary with patch validation code, gather and view patch validation data resulted from executing the instrumented target binary. FIG. 2 illustrates an exemplary runtime patch validation program 114 and will be described in detail later. Furthermore, the memory 104 may be configured to store patch validation data for processing, transmission, and display in accordance with embodiments of the invention.

In the illustrated embodiment, the computer system 100 further includes a mass storage 116. The mass storage 116 comprises facilities such as one or more CD-RW/DVD-RW drives, hard disk drives, tape drives, etc., or combinations thereof, that can be utilized to store patch validation data. All components of the computer system 100 may be communicatively connected together to a network interface 108 by a communication bus 110. The network interface 108 includes the necessary hardware and software to allow the computer system 100 to communicate with other computing devices connected to the same network by use of one or more suitable communication protocols, such as TCP/IP protocol.

For ease of illustration, FIG. 1 does not show other typical components of a computing system, such as input/output device, a video display adapter, power supply, computer monitor, etc. However, those of ordinary skill in the art of computers will recognize a wide selection of commercially-available components that can be used to construct and operate a computing system such as the computer system 100 illustrated in FIG. 1.

FIG. 2 illustrates an exemplary runtime patch validation program 114. As shown in FIG. 2, the runtime patch validation program 114 includes a hotpatching mechanism 218, which is a mechanism for inserting patch validation code into an in-use target binary. The hotpatching mechanism 218 automatically instruments a running target binary on a computer system such as the computer system 100 illustrated in FIG. 1 without requiring any interruption of the service on the computer system. The hotpatching mechanism 218 instruments a running software program by loading patch validation code into memory and modifying an instruction in the target binary to jump to the patch validation code. A detailed description of an exemplary implementation of the hotpatching mechanism 218 is provided in U.S. patent application Ser. No. 10/307,902, filed on Dec. 2, 2002, titled PATCHING OF IN-USE FUNCTIONS ON A RUNNING COMPUTER SYSTEM, assigned to the assignee of the present invention, and hereby incorporated by reference.

The exemplary runtime patch validation program 114 further includes a patch validation server process component 220 (patchsrv.exe). The patch validation server process component 220 logs data produced by the inserted patch validation code in a target binary. In an exemplary embodiment of the invention, the patch validation server process component 220 shares its memory with the instrumented target binary. Consequently, the patch validation server process component 220 can read any trace information produced by the patch validation code and expose such information for a user to view. In some embodiments of the invention, the patch validation server process component 220 is responsible for (a) initializing the memory it shares with the instrumented target binary, (b) patching the target binary with patch validation code, (c) reading patch validation data produced by the instrumented target binary from the shared memory, (d) logging and displaying the patch validation data according to user preference, and (e) removing the patch validation code from the target binary upon request.

In embodiments of the invention, the patch validation server process component 220 includes at least two major functionalities: collecting patch validation data and logging the data. The patch validation data collected by the patch validation server process component 220 is used to determine the impact of a patch to a target binary. Such data may uniquely identify the name and code path of the file that contains the patch. Such data may also identify the specific version of the patch, the size of the patch file, etc. The collected data may also identify the function name and/or the line number in the patch that provides the change for the target binary. The collected data may also provide information to determine under what conditions the target binary uses the code that is to be patched. Such information may include specific function calls that precede the to-be-patched code to provide context for the patching. Such information may also provide the user context such as the user name or domain name that the target binary operates under. Such information may identify number of times that the target binary has hit the to-be-patched code. Data collected by the patch validation server process component 220 may also include information that identifies the target binary that uses the patch. Such information includes the name of the target binary, the process ID that identifies the target binary, code paths to the target binary's executable image, version of the image, size of the image, etc.

Another functionality provided by the patch validation server process component 220 defines how to log the collected patch validation data. The patch validation server process component 220 may provide multiple options for logging patch validation data gathered from an instrumented target binary. For example, patch validation data can be logged locally to the computer system that the target binary runs on. Alternatively, patch validation data can be logged remotely to another computer system. Patch validation data can also be logged to a graphic user interface for near real time analysis.

In some embodiments of the invention, the runtime patch validation program 114 also includes a patch validation logging interface 222. The patch validation logging interface 222 may be abstracted by a DLL file such as patchv.dll. This component includes code that enables an instrumented user-mode target binary to communicate with the patch validation server process 220. For example, the patch validation logging interface 222 may establish a communication path between the patch validation server process component 220 and an instrumented user-mode target binary through an LPC interface. Preferably, a user can configure the patch validation logging interface 222 to, for example, to turn on or off the logging function provided by the patch validation server process component 220, and/or to specify the logging options provided by the patch validation server process component 220.

As known by those of ordinary skill in the art, a target binary may run in a computer system either in a user mode or in a kernel mode. Processes that run in user mode execute within their own virtual address spaces. Such processes are called user-mode processes. User-mode processes are restricted from gaining direct access to many parts of a computer system, including system software, memory not allocated for user mode, and other portions of the computer system that might compromise system integrity. User-mode processes are effectively isolated from kernel-mode processes and other user-mode processes. Software programs launched by users are generally in the user mode. In contrast, kernel-mode processes can directly access system data and hardware, and are not restricted like user-mode processes. Performance-sensitive drivers and operating system components are usually run in kernel mode in order to interact with system hardware more efficiently. All kernel-mode processes are fully protected from processes running in user mode. Kernel-mode processes have unlimited access to system memory and external devices. In exemplary embodiments of the invention, the runtime patch validation program 214 deals with a kernel-mode target binary differently from a user-mode target binary.

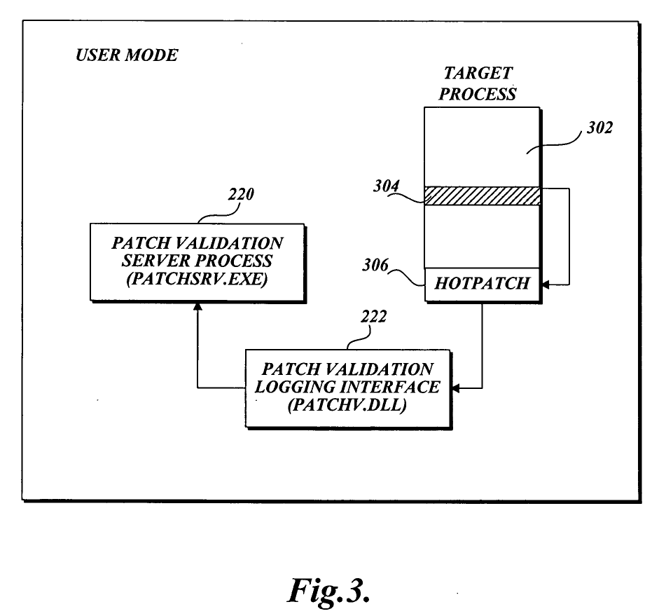

FIG. 3 illustrates runtime patch validation of a user-mode target binary, such as a target process 302. As shown in FIG. 3, the target process 302 includes a section of code 304 that is to be affected by a patch. The hotpatching mechanism 218 (FIG. 2) enables a jump to be placed right before the to-be-patched code 304. During execution, upon encountering the jump, the target process 302 jumps to a hotpatch 306 that is installed by the hotpatching mechanism 218 and contains patch validation code examining current values of pertinent variables, code paths, etc. The hotpatch 306 also communicates with the patch validation server process component 220 through the patch validation logging interface 222. In exemplary embodiments of the invention, the communication between the patch validation logging interface 222 and the patch validation server process 220 is established through an LPC interface.

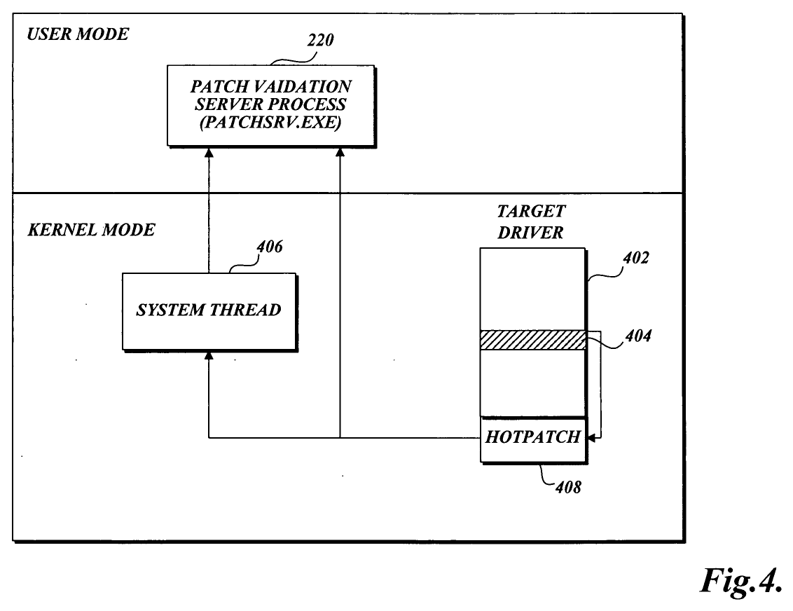

FIG. 4 illustrates runtime patch validation of a kernel-mode target binary, such as a target driver 402. As shown in FIG. 4, the target driver 402 contains a to-be-patched code 404. The hotpatching mechanism 218 (FIG. 2) enables a jump to be placed right before the to-be-patched code 404. During execution, upon encountering the jump, the target driver 402 jumps to a hotpatch 408 that is installed by the hotpatching mechanism 218 and contains patch validation code examining variables and properties pertinent to patch validation. In exemplary embodiments of the invention, the hotpatch 408 communicates directly with the patch validation server process component 220 if the value of the IRQL for the processor that executes the target driver 402 is less than 2. Otherwise, the patch validation data gathered from the instrumented target driver 402 are communicated to the patch validation server process component 220 through a system thread 406. As known by those of ordinary skill in the art, IRQL stands for interrupt request level, which indicates the priority ranking of an interrupt. A processor usually has an IRQL setting that threads can increase or decrease. Interrupts that occur at or below a processor's IRQL setting are masked and will not interfere with the current operation of the processor. On the other hand, interrupts that occur above the processor's IRQL setting take precedence over the current operation. The particular IRQL at which a piece of kernel-mode code executes determines its hardware priority.

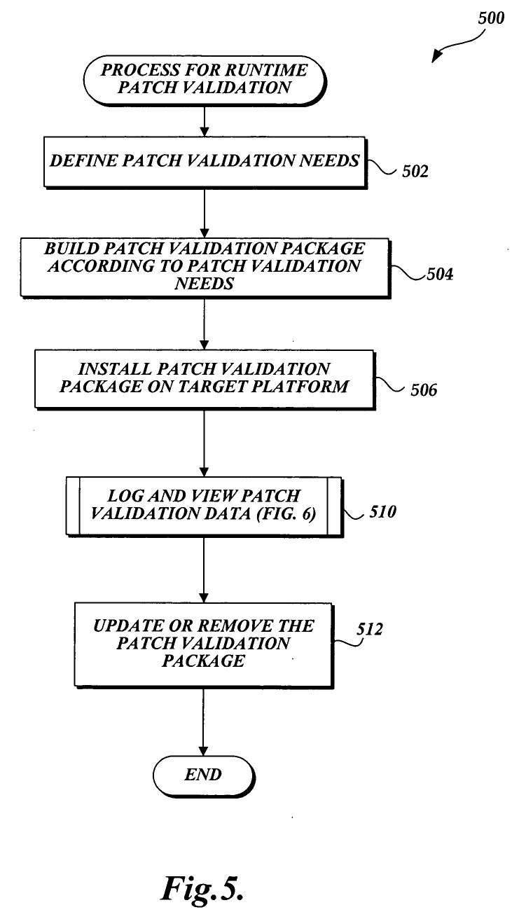

FIG. 5 illustrates an exemplary process 500 for runtime patch validation of a running target binary. As shown in FIG. 5, the process 500 starts by defining patch validation needs for the target binary. See block 502. Patch validation needs dictate what patch validation data to collect from the instrumented target binary. Patch validation needs may include identifying the file that contains the patch, the specific version of the patch, and the specific conditions that the target binary will be under in order to use the to-be-patched code, etc. After identifying the patch validation needs, the process 500 proceeds to build a patch validation package according to the defined patch validation needs. See block 504. As described above with regard to the exemplary runtime patch validation program 114 (FIG. 2), the patch validation package may include a patch validation server process component patchsrv.exe and a run-time patching mechanism such as the hotpatching mechanism 218 illustrated in FIG. 2, and/or a patch validation logging interface patchv.dll.

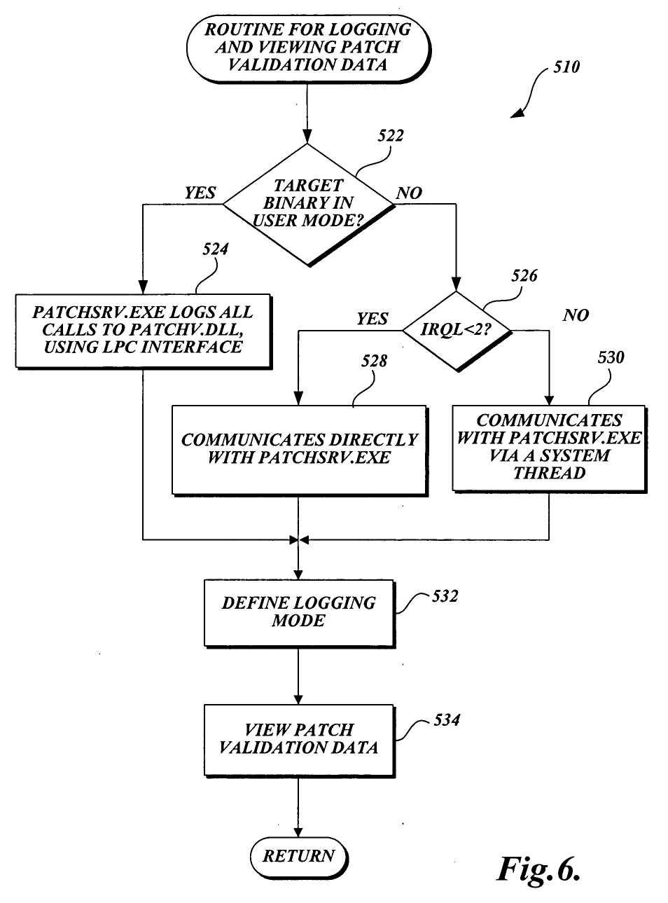

After building the patch validation package based on specified patch validation needs, the process 500 then proceeds to install the patch validation package on the target platform where the target binary is running. See block 506. The installation enables the target binary to be hotpatched with patch validation code addressing the defined patch validation needs. After installing the patch validation package on the target platform, the process 500 proceeds to execute a routine 510 that enables the logging and viewing of patch validation data resulted from the execution of the instrumented target binary. See block 510. FIG. 6 is a flow diagram illustrating an exemplary routine 510 and will be discussed in detail later.

After having enabled the logging and viewing of patch validation data from an instrumented target binary, the process 500 proceeds to update or remove the patch validation package. See block 512. In some embodiments of the invention, a new version of patch validation code may be installed over an old version of the patch validation code. Alternatively, the old version of the patch validation code may be removed before a new version of the patch validation code is installed. After updating or removing the old patch validation package, the process 500 terminates.

FIG. 6 illustrates an exemplary implementation of the routine 510 that enables the logging and viewing of patch validation data. The routine 510 starts by determining whether the running target binary is in a user mode or in a kernel mode. See decision block 522. If the target binary is in a user mode, the patch validation server process patchsrv.exe logs all calls to the patch validation logging interface patchv.dll through an LPC interface. See block 524.

If the answer to decision block 522 is NO, meaning that the target binary is in a kernel mode, the routine 510 proceeds to determine whether the value of the IRQL of the processor executing the target binary is less than 2. See decision block 526. If the value of the IRQL is less than 2, the instrumented target binary communicates directly with the patch validation server process patchsrv.exe. See block 528. Otherwise, the instrumented target binary communicates with the patch validation server process patchsrv.exe via a system thread. See block 530. For any of the three approaches (blocks 524, 528, and 530) of communicating with the patch validation server process patchsrv.exe, embodiments of the invention provide one or more logging modes. An exemplary embodiment of the invention allows patch validation data to be written, for example, to a real time console, to the local system, or to a remote system. Consequently, the routine 510 allows the specification of a logging mode. See block 532. In addition, some embodiments of the invention also provide different interfaces for a user to view the logged patch validation data. See block 534. Such a view can be through a command-line console or through a graphic user interface, for example. The routine 510 then returns.

While preferred embodiments of the invention have been illustrated and described, it will be appreciated that various changes can be made therein without departing from the spirit and scope of the invention.

The embodiments of the invention in which an exclusive property or privilege is claimed are defined as follows:

1. A software system for runtime patch validation of an in-use function (“target binary”), comprising:
a patching mechanism that instruments the target binary with patch validation code when the target binary is running; and
a patch validation server process component that gathers patch validation data resulted from running the instrumented target binary.

2. The software system of claim 1, further comprising a patch validation logging interface, through which a user-mode target binary communicates with the patch validation server process component.

3. A computer-implemented method for runtime patch validation of an in-use function (“target binary”), comprising:
building a patch validation package according to one or more specified patch validation needs for validating a patch for the target binary;
installing the patch validation package on a platform that the target binary is running on; and
gathering patch validation data resulted from executing the target binary.

4. The computer-implemented method of claim 3, wherein the patch validation package includes:
patch validation code addressing the one or more specified patch validation needs;
a patching mechanism that instruments the target binary with the patch validation code when the target binary is running; and
a patch validation server process component that gathers patch validation data resulted from running the instrumented target binary.

5. The computer-implemented method of claim 4, wherein the patch validation package further includes a patch validation logging interface, through which a user-mode target binary communicates with the patch validation server process component.

6. The computer-implemented method of claim 4, wherein installing the patch validation package on a target platform that the target binary is running on includes:
loading the patch validation code; and
inserting a jump before code in the target binary that is to be affected by the patch, wherein the execution of the jump leads to the patch validation code.

7. The computer-implemented method of claim 3, wherein gathering patch validation data resulted from executing the target binary includes storing the patch validation data to a location selected from a group consisting of a location local to the platform executing the target binary and a location on a remote platform.

8. The computer-implemented method of claim 3, further comprising providing a viewing interface for the patch validation data.

9. The computer-implemented method of claim 8, wherein the patch validation data can be viewed off-line or near real time.

10. The computer-implemented method of claim 3, further comprising, after gathering the patch validation data, removing or replacing the patch validation package.

11. The computer-implemented method of claim 4, wherein the target binary communicates with the patch validation server process component via a system thread if the target binary is in kernel mode and the IRQL value of the processor running the target binary is no less than 2.

12. The computer-implemented method of claim 4, wherein the target binary communicates with the patch validation server process component directly if the target binary is in kernel mode and the IRQL value of the processor running the target binary is less than 2.

13. A computer system for runtime patch validation of an in-use function (“target binary”), comprising
(a) A memory; and
(b) A processor, coupled with the memory, for
(i) building a patch validation package according to one or more specified patch validation needs for validating a patch for the target binary;
(ii) installing the patch validation package on a target platform that the target binary is running on; and
(iii) gathering patch validation data resulted from executing the target binary.

14. The computer system of claim 13, wherein the patch validation package includes:
patch validation code addressing the one or more specified patch validation needs;
a patching mechanism that instruments the target binary with the patch validation code when the target binary is running; and
a patch validation server process component that gathers patch validation data resulted from running the instrumented target binary.

15. The computer system of claim 14, wherein the patch validation package further includes a patch validation logging interface, through which a user-mode target binary communicates with the patch validation server process component.

16. The computer system of claim 14, wherein the processor installs the patch validation package on a platform that the target binary is running on by:
loading the patch validation code; and
inserting a jump before code in the target binary that is to be affected by the patch, wherein the execution of the jump leads to the patch validation code.

17. The computer system of claim 13, wherein the processor stores the patch validation data to a location selected from a group consisting of a location local to the platform executing the target binary and a location on a remote platform.

18. The computer system of claim 13, wherein the patch validation data can be viewed off-line or near real time.

19. The computer system of claim 14, wherein the target binary communicate with the patch validation server process component via a system thread if the target binary is in kernel mode and the IRQL value of the processor running the target binary is no less than 2.

20. The computer system of claim 14, wherein the target binary communicate with the patch validation server process component directly if the target binary is in kernel mode and the IRQL value of the processor running the target binary is less than 2.
